(19) United States
(12) Patent Application Publication
(10) Pub. No.: US 2022/0115721 A1
(43) Pub. Date: Apr. 14, 2022

(54) Household Energy Storage Constant Temperature Battery System

(71) Applicant: FranklinWH Technologies Co., Ltd., Shenzhen (CN)

(72) Inventors: Daqing Wang, Shenzhen (CN); Yuezhen Hu, Shenzhen (CN); Haisheng Song, Shenzhen (CN)

(21) Appl. No.: 17/560,456

(22) Filed: Dec. 23, 2021

Related U.S. Application Data
(63) Continuation of application No. PCT/CN2020/113405, filed on Sep. 4, 2020.

(30) Foreign Application Priority Data
Jul. 3, 2020 (CN) 202010635887.7

(51) Int. Cl. H01M 10/6572; H01M 10/613; H01M 10/635; H01M 10/6554

(52) U.S. Cl. CPC H01M 10/6572; H01M 10/6554; H01M 10/635; H01M 10/613

(57) ABSTRACT

The present application discloses a household energy storage constant temperature battery system, comprising: a battery module including a battery pack and at least one group of battery cores; the battery pack includes a heat conducting plate, the heat conducting plate includes a battery end and a first heat dissipation end, and each group of the battery cores are arranged in contact with the battery end and enclosed in the battery pack; a heat dissipation module, including at least one TEC module, a temperature sensor and a control module, wherein each TEC module is arranged in contact with the first heat dissipation end, the temperature sensor is configured to sense temperature of each group of the battery cores, and the control module is configured to control current magnitude and current direction provided to the at least one TEC module according to the temperature of each group of the battery cores.

### CROSS REFERENCE TO RELATED APPLICATIONS

The present application is a Continuation Application of PCT Application No. PCT/CN2020/113405 filed on Sep. 4, 2020, which claims the priority of Chinese patent application No. 202010635887.7, filed with China Patent Office on Jul. 3, 2020, and the contents of which are incorporated herein by reference in their entirety.

### TECHNICAL FIELD

The present disclosure relates to battery technology, for example, to a household energy storage constant temperature battery system.

### BACKGROUND

Household energy storage battery system adopts a structured battery pack to contain a lithium battery core, realizing IP67 waterproof and dustproof design and providing a safe and reliable working environment for batteries.

When the lithium battery core works in a sealed structure of battery pack, the working temperature of the lithium battery core would rise above 45° C. at room temperature. But the best working temperature for lithium battery core is around 25° C. At 45° C., the working life cycle of lithium battery core would attenuate by more than 50%.

Household energy storage battery system adopts natural heat dissipation, fan heat dissipation or liquid cooling heat dissipation, but these heat dissipation methods would still make the working temperature of lithium battery core higher than the ambient temperature, which will seriously affect the working service life of lithium battery core. In addition, the charging of lithium batteries is required to be above 0° C. When the temperature is low in winter, the charging and discharging performance of lithium batteries is greatly affected by low temperature.

### SUMMARY

The disclosure provides a household energy storage constant temperature battery system, aiming to maintain the constant temperature for lithium battery core of household energy storage products.

The disclosure provides a household energy storage constant temperature battery system, including:

a battery module, including a battery pack and at least one group of battery cores, wherein the battery pack includes a heat conducting plate, and the heat conducting plate includes a battery end and a first heat dissipation end, and each group of the battery cores are arranged in contact with the battery end and enclosed in the battery pack;

a heat dissipation module, including at least one TEC module, a temperature sensor and a control module, wherein each TEC module is arranged in contact with the first heat dissipation end, the temperature sensor is configured to sense temperature of each group of the battery cores, and the control module is configured to control current magnitude and current direction provided to the at least one TEC module according to the temperature of each group of the battery cores.

### BRIEF DESCRIPTION OF DRAWINGS

FIG. 1 is a side view of the structural schematic diagram of a household energy storage constant temperature battery system provided by Embodiment one of the present application;

FIG. 2 is a side view of the structural schematic diagram of a household energy storage constant temperature battery system provided by Embodiment two of the present application;

FIG. 3 is a top view of the structural schematic diagram showing the connection relationship between the TEC module and control module of a household energy storage constant temperature battery system provided by Embodiment two of the present application;

FIG. 4 is a top view of the structural schematic diagram showing the connection relationship between the TEC module and control module of a household energy storage constant temperature battery system provided by Embodiment two of the present application.

Battery Pack 120; Battery Core 110; Heat Conducting Plate 121; Battery End (Battery Contact Surface) 122; First Heat Dissipation End (Heat Dissipation Contact Surface) 123; Semiconductor Cooler (Thermo Electric Cooler; TEC) Module 210; Temperature Sensor 220; Control Module 230; TEC Chip 211; TEC Radiator 212; Temperature Control End 213; Second Heat Dissipation End 214; Heat Pipe Structure 300; Battery Management System 231.

### DETAILED DESCRIPTION OF DISCLOSED EMBODIMENTS

The present disclosure will be described with reference to the drawings and embodiments below. Only some but not all structures related to the present disclosure are shown in the drawings.

Further, that term “first,” “second,” and the like may be used herein to describe various direction, actions, steps, or elements, etc., but those direction, actions, steps, or elements are not limited by these terms. These terms are only used to distinguish the first direction, action, step or element from another direction, action, step or element. For example, without departing from the scope of the present application, the first heat dissipation end may be referred to as second heat dissipation end, and similarly, the second heat dissipation end may be referred to as first heat dissipation end. The first heat dissipation end and second heat dissipation end are both heat dissipation ends, but the first heat dissipation end and the second heat dissipation end are not the same heat dissipation end. The terms “first”, “second” and so on cannot be understood as indicating or implying relative importance or implicitly indicating the number of the technical features. Thus, the features defined by “first” and “second” may explicitly or implicitly include one or more of the features. In the description of the embodiments of the present application, “a plurality of” means at least two, such as two, three, etc., unless otherwise explicitly defined. And the singular terms “a”, “an” and “the” include plural reference and vice versa unless the context clearly indicates otherwise.

### Embodiment 1

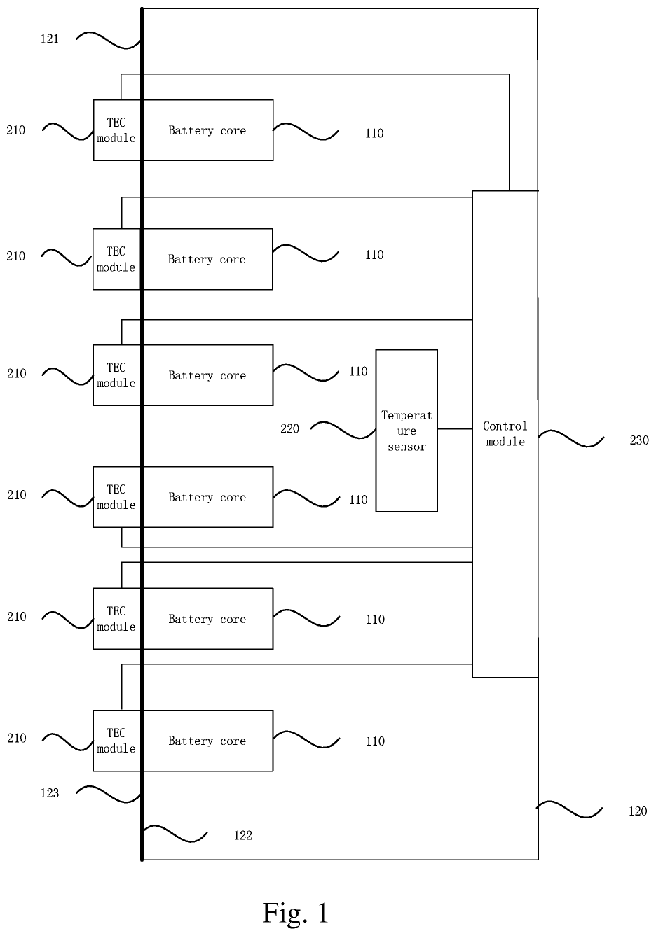

As shown in FIG. 1, Embodiment one of the present application provides a household energy storage constant temperature battery system, which includes a battery module and a heat dissipation module.

In an embodiment, the battery module includes a battery pack 120 and at least one group of battery cores 110 housed in the battery pack 120, the battery pack 120 includes a heat conducting plate 121, and the heat conducting plate 121 includes a battery end (battery contact surface) 122 and a first heat dissipation end (heat dissipation contact surface) 123, and each group of the battery cores 110 are arranged in contact with the battery end 122 and enclosed in the battery pack 120; the heat dissipation module includes at least one semiconductor cooler (Thermo Electric Cooler; TEC) module 210, a temperature sensor 220 and a control module 230, each TEC module 210 is arranged in contact with the first heat dissipation end 123, the temperature sensor 220 is configured to sense temperature of each group of the battery cores 110, and the control module 230 is configured to control current magnitude and current direction provided to the at least one TEC module 210 according to the temperature of each group of the battery cores 110.

In this embodiment, the battery cores 110 are lithium battery cores, and each group of the battery cores 110 is housed in a battery pack (CORE PACK), which is not shown in the figures. There are one group or multiple groups of battery cores 110. The battery pack 120 may enclose 2-12 groups of battery cores 110. In this embodiment, 6 groups of battery cores 110 are enclosed in the battery pack 120. TEC module 210 absorbs heat at one end and releases heat at the other end by adopting Peltier effect of semiconductor materials. Therefore, heat release or heat absorption can be realized by changing the magnitude and direction of current supplied to the TEC module 210, so as to realize heating or heat dissipation for the battery core 110. There may be one or more TEC modules 210, for example, 2-12. In order to achieve better temperature control effect on the premise of cost control, in this embodiment, there is one-to-one correspondence between each TEC module 210 and the positions of each group of the battery core 110 on the heat conducting plate 121, that is, there are six TEC modules 210, and the positions of each TEC module 210 on the heat conducting plate 121 are one-to-one correspondence with the positions of each group of the battery cores 110. Temperature sensor 220 is a non-contact sensor, which determines the temperature of each group of the battery cores 110 by sensing the temperature field in the current battery pack 120 and the positions of each group of the battery cores 110. In an embodiment, the temperature sensor 220 can also be used to sense the ambient temperature, etc. In addition, each TEC module 210 is electrically connected with a control module 230 individually, the control module 230 can independently control the current magnitude and current direction of each TEC module 210, and the control module 230 may be arranged inside the battery pack 120, or may be arranged outside the battery pack 120. In this embodiment, the control module 230 is arranged inside the battery pack 120.

In an alternative embodiment, in order to keep the circuit simple, a plurality of TEC modules 210 may be connected in series and then electrically connected with the control module 230. In an alternative embodiment, the temperature sensors 220 are 2-12 contact sensors, and exemplarily, there are 6 temperature sensors 220, which are respectively arranged on each group of battery cores 110.

For example, the temperature sensor 220 would continuously sense the temperature of the battery core 110 corresponding to the temperature sensor 220 in real time. When that temperature sensor 220 detect that the sensed temperature of the battery core 110 corresponding to the temperature sensor 220 is higher than a preset value, the control module 230 would provide a current in the first current direction to the TEC module 210 in the same position as the battery core 110, so that the end of the TEC module 210 near the battery core 110 absorbs heat. If the temperature of the battery core 110 is still higher than the preset value within a first preset time, the control module 230 would increase the current, because the heat emitted by the battery core 110 would be distributed on the heat conducting plate 121, if the current reaches the peak value and the temperature of the battery core 110 is still higher than the preset value within a second preset time, the control module 230 may provide the current in the first current direction to the two TEC modules 210 adjacent to the battery core 110, so that one end of the two TEC modules 210 near the battery core 110 absorbs heat to help absorb heat on the heat conducting plate 121. Adaptively, if the temperature of the battery core 110 cannot be lowered all the time, the control module 230 may continue to enable more TEC modules 210 to work or increase their currents. Similarly, if one of the TEC modules 210 fails, the control module 230 may take the same action to make the two TEC modules 210 adjacent to this TEC module 210 work to help control the temperature.

In addition, if the temperature sensor 220 detects that the sensed temperature of the battery core 110 corresponding to the temperature sensor 220 is lower than the preset value, the working flow of the control module 230 is the same as that described above, except that the control module 230 provides a current in the second current direction to the TEC module 210, so that one end near the battery core 110 radiates heat. Therefore, the control module 230 can control the magnitude and direction of the current supplied to the TEC module 210 according to the temperature of each group of battery cores 110, and keep the battery core 110 at a constant temperature, for example, keep the temperature of the battery core 110 at 20° C.-30° C., optionally 25° C.

The embodiment of the present application provides a battery module, including a battery pack 120 and at least one group of battery cores 110, the battery pack 120 includes a heat conducting plate 121, the heat conducting plate 121 includes a battery end 122 and a first heat dissipation end 123. Each group of the battery cores 110 is arranged in contact with the battery end 122 and housed in the battery pack 120 in a closed manner; also provided is a heat dissipation module, including at least one TEC module 210, a temperature sensor 220 and a control module 230, each TEC module 210 is arranged in contact with the first heat dissipation end 123, the temperature sensor 220 is configured to sense the temperature of each group of the battery cores 110, and the control module 230 is configured to control the magnitude and direction of the current supplied to the TEC module 210 according to the temperature of each group of the battery cores 110, thus solving the problem that the lithium battery cores 110 have poor heat dissipation effect and cannot heat up, and achieving the effect of maintaining the constant temperature of the lithium battery core 110.

### Embodiment 2

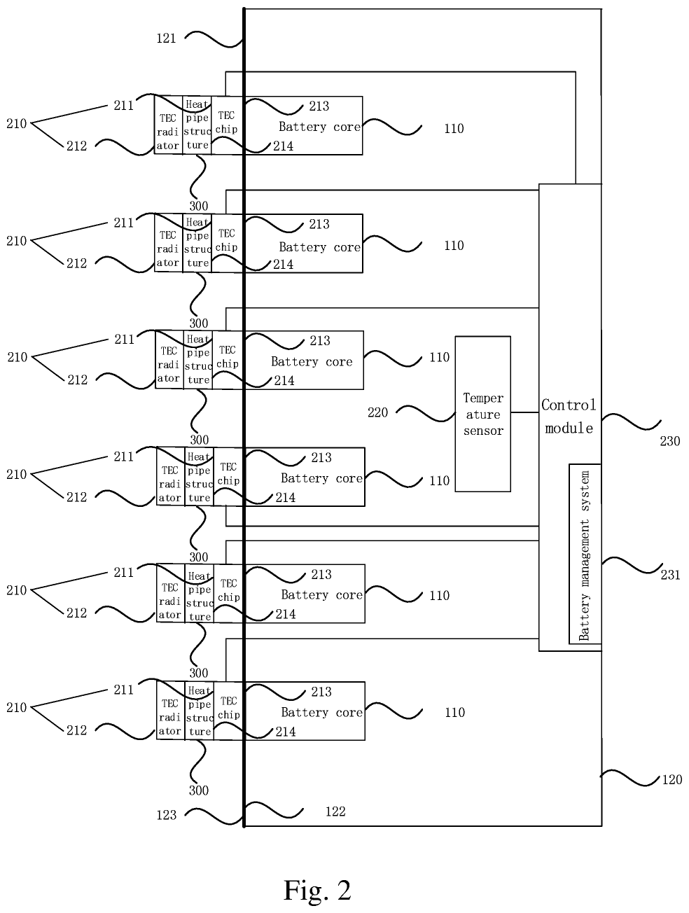

As shown in FIG. 2, the embodiment of the present application provides a household energy storage constant temperature battery system, and Embodiment two of the present application is based on Embodiment one of the present application.

In this embodiment, each TEC module 210 includes at least one TEC chip 211 and a TEC radiator 212, and each TEC chip 211 includes a temperature control end 213 and a second heat dissipation end 214. TEC radiator 212 is located at the second heat dissipation end 214, and the temperature control end 213 is arranged in contact with the first heat dissipation end 123. TEC radiator 212 can meet the requirement that TEC module 210 works at the best Coefficient Of Performance (COP) refrigeration point, and improve the working efficiency of TEC module 210. In an embodiment, the TEC radiator 212 may be a fin radiator, a liquid-cooled radiator or a phase change heat exchanger. In order to better realize the temperature control effect, the positions of the TEC module 210 and the battery core 110 on the heat conducting plate 121 are one-to-one correspondence, and at least one TEC module 210 is evenly distributed on the heat conducting plate 121. In this way, even if one TEC module 210 is damaged, the current magnitude of the TEC module 210 adjacent to one TEC module 210 can be controlled by the control module 230, so as to ensure the effect of stable constant temperature control and effectively improve the temperature uniformity of the battery core 110 in the household energy storage constant temperature battery system. Therefore, when at least one TEC module is plural, the plurality of TEC modules 210 are electrically connected with the control module 230 after being connected in series and/or in parallel, so as to ensure the simplicity of the connection circuit and realize the independent control of each TEC module 210. According to the actual situation of the battery core 110 arrangement position, the connection mode of the TEC module 210 may also be set accordingly. Optionally, each group of battery core 110 may be correspondingly provided with a plurality of TEC modules 210 for temperature control.

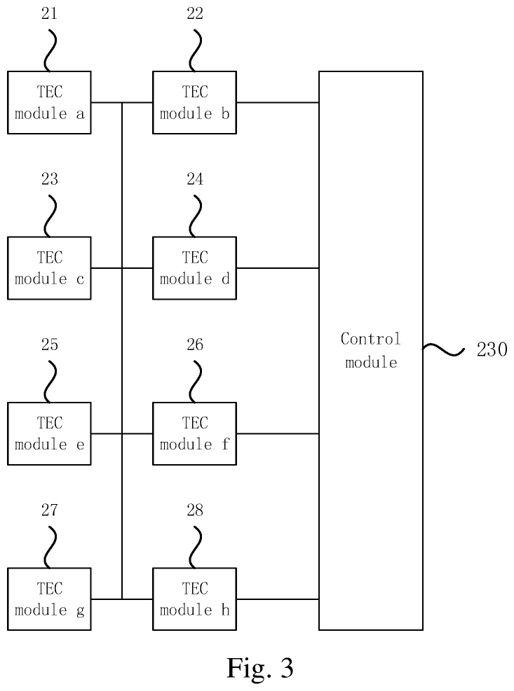

In an embodiment, the household energy storage constant temperature battery system includes a plurality of TEC series branches, each TEC series branch includes the same or different number of TEC modules 210, the TEC modules 210 in each TEC series branch are connected to the control module 230 in series, and the TEC modules 210 in different TEC series branches are connected correspondingly in parallel or bridged. There may be 4 to 24 TEC modules 210. In one embodiment, as shown in FIG. 3, the household energy storage constant temperature battery system is provided with 8 TEC modules, TEC module a21, TEC module b22 and control module 230 are connected in series; TEC module c23, TEC module d24 and control module 230 are connected in series; TEC module e25, TEC module f26 and control module 230 are connected in series; TEC module g27, TEC module h28 and control module 230 are connected in series; and TEC module a21, TEC module b22, TEC module c23 and TEC module d24 are connected in parallel; TEC module c23, TEC module d24, TEC module e25 and TEC module f26 are connected in parallel, and TEC module e25, TEC module f26, TEC module g27 and TEC module h28 are connected in parallel. For example, if TEC module d24 fails, the battery core 110 corresponding to TEC module d24 cannot realize temperature control. In this case, the control module 230 may increase the current magnitude of TEC module b22, TEC module c23 and TEC module f26 by this connection mode. The control module 230 controls TEC module c23 by the connection line through TEC module b22 or TEC module f26, thereby realizing the temperature control of the battery core corresponding to TEC module d24.

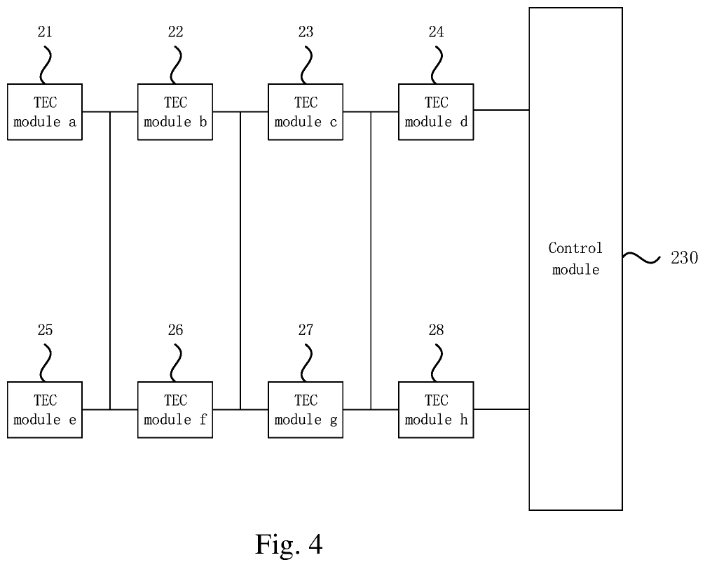

In another embodiment, the household energy storage constant temperature battery system includes a plurality of TEC series branches, each TEC series branch includes the same or different number of TEC modules 210, the TEC modules 210 in each TEC series branch are connected to the control module 230 in series, and the TEC modules 210 in different TEC series branches are connected correspondingly in parallel or bridged. As shown in FIG. 4, the household energy storage constant temperature battery system is provided with 8 TEC modules, TEC module a21, TEC module b22, TEC module c23, TEC module d24 and control module 230 are connected in series; TEC module e25, TEC module f26, TEC module g27, TEC module h28 and control module 230 are connected in series; and TEC module a21, TEC module b22, TEC module e25 and TEC module f26 are connected in parallel; TEC module b22, TEC module c23, TEC module f26 and TEC module g27 are connected in parallel, and TEC module c23, TEC module d24, TEC module g27 and TEC module h28 are connected in parallel. For example, if the battery core corresponding to TEC module c23 fails, the control module 230 may increase the current magnitude of TEC module b22, TEC module d24 and TEC module g27 by this connection mode. The control module 230 controls TEC module b22 by the connection line between TEC module h28 and the TEC module g27, thereby realizing the temperature control of the battery core corresponding to the TEC module c23.

In an embodiment, in each TEC module, a heat pipe structure 300 may also be arranged between the at least one TEC chip 211 and the TEC radiator 212. In this case, one end of the heat pipe structure 300 is arranged in contact with the second heat dissipation end 214, and the other end of the heat pipe structure 300 is arranged in contact with the TEC radiator 212. Optionally, the heat pipe structure 300 includes a heat pipe and a silicone pad, the heat pipe may be copper phase change heat pipe or other phase change radiators, and the material of the heat conducting plate 121 is aluminum, so that the heat transfer resistance is small and the temperature of battery core 110 can be promptly controlled. In an embodiment, the control module 230 further includes a battery management system 231, the battery management system 231 is electrically connected with at least one group of battery cores 110, which intelligently manages and maintains at least one group of battery cores 110, and can cooperate with the heat dissipation module to achieve the best working efficiency and working life cycle of the battery module. The connection lines in the drawings are only schematic. In actual situation, the connection lines include zero line and live line.

In an alternative embodiment, one or more external heat dissipation fans may also be arranged at each TEC radiator 212 to further help heat dissipation and prevent the TEC radiator 212 from aging due to excessive temperature.

According to the embodiment of the present application, the positions of the TEC module 210 and the battery core 110 on the heat conducting plate 121 are in one-to-one correspondence, and each TEC module 210 is evenly distributed on the heat conducting plate 121, each TEC module 210 is electrically connected with the control module 230 after being connected in series and/or in parallel, which solves the problem that the corresponding battery core 110 can't be kept constant temperature when the TEC module 210 fails, and realizes that the self-adaption of temperature control work of the household energy storage constant temperature battery system is not affected, and the reliability is high, and improves the temperature uniformity of the battery core 110 in the household energy storage constant temperature battery system.

What is claimed is:

1. A household energy storage constant temperature battery system, comprising:
a battery module, comprising a battery pack and at least one group of battery cores, wherein the battery pack comprises a heat conducting plate, and the heat conducting plate comprises a battery end and a first heat dissipation end, and each group of the battery cores are arranged in contact with the battery end and enclosed in the battery pack;
a heat dissipation module, comprising at least one semiconductor cooler TEC module, a temperature sensor and a control module, wherein each TEC module is arranged in contact with the first heat dissipation end, the temperature sensor is configured to sense temperature of each group of the battery cores, and the control module is configured to control current magnitude and current direction provided to the at least one TEC module according to the temperature of each group of the battery cores.

2. The household energy storage constant temperature battery system of claim 1, wherein each TEC module comprises at least one TEC chip and a TEC radiator, and each TEC chip comprises a temperature control end and a second heat dissipation end, the TEC radiator is located at the second heat dissipation end, and the temperature control end is arranged in contact with and the first heat dissipation end.

3. The household energy storage constant temperature battery system of claim 1, wherein each TEC module corresponds to positions of each group of the battery cores on the heat conducting plate one by one.

4. The household energy storage constant temperature battery system of claim 1, wherein at least one TEC module is uniformly distributed on the heat conducting plate.

5. The household energy storage constant temperature battery system of claim 1, wherein each TEC module is electrically connected with the control module individually.

6. The household energy storage constant temperature battery system of claim 1, wherein when at least one TEC module is a plurality of TEC modules, the plurality of TEC modules are connected in at least one of the following ways: series connection and parallel connection, and the connected plurality of TEC modules are electrically connected with the control module.

7. The household energy storage constant temperature battery system of claim 2, wherein in each TEC module, a heat pipe structure is further arranged between the at least one TEC chip and the TEC radiator.

8. The household energy storage constant temperature battery system of claim 7, wherein the heat pipe structure comprises a heat pipe and a silicone pad.

9. The household energy storage constant temperature battery system of claim 8, wherein the material of the heat conducting plate is aluminum.

10. The household energy storage constant temperature battery system of claim 1, wherein the control module further comprises a battery management system, and the battery management system is electrically connected with the at least one group of battery cores.
